(19) United States
(12) Patent Application Publication
(10) Pub. No.: US 2016/0102672 A1
(43) Pub. Date: Apr. 14, 2016

(54) BEARING STRUCTURE AND FAN THEREOF

(71) Applicant: Asia Vital Components Co., Ltd., New Taipei City (TW)

(72) Inventors: Feng Liu, New Taipei City (TW); Changli Tang, New Taipei City (TW)

(21) Appl. No.: 14/510,128

(22) Filed: Oct. 9, 2014

(51) Int. Cl. F04D 29/058; H02K 7/08; F04D 29/32; F04D 19/00; F04D 25/06; F04D 29/053; H02K 7/09; F16C 32/04

(52) U.S. Cl. CPC F04D 29/058; H02K 7/09; H02K 7/085; F16C 32/0406; F04D 19/002; F04D 25/06; F04D 29/053; F04D 29/329

(57) ABSTRACT

A bearing structure and a fan thereof. The fan has a fan impeller and a rotary shaft connected with the fan impeller. The rotary shaft has a free end inserted in the bearing structure. The bearing structure includes a bearing cup. A bearing member and a first magnetic member are received in the bearing cup. The first magnetic member has a first magnetic face radially facing the rotary shaft. By means of the bearing member and the first magnetic member, the fan impeller can keep stably operating.

### BACKGROUND OF THE INVENTION

1. Field of the Invention

The present invention relates generally to a bearing structure, and more particularly to a magnetic fan bearing structure.

2. Description of the Related Art

Please refer to FIG. 1, which shows a conventional fan 10. The conventional fan 10 has a base seat 11 and a bearing cup 111 protruding from the base seat 11. A stator assembly 12 is fitted around the bearing cup 111. An upper bearing 131 and a lower bearing 132 are disposed in the bearing cup 111. The bearing cup 111 has an inner flange section 133 positioned between the upper and lower bearings 131, 132. The inner flange section 133 protrudes from inner circumference of the bearing cup 111 toward the center thereof. A spring 14 is disposed under the inner flange section 133 and positioned between the inner flange section 133 and the lower bearing 132. A fan impeller 15 has a rotor assembly 151 corresponding to the stator assembly 12. The fan impeller 15 is connected with a rotary shaft 152. The rotary shaft 152 has a free end 1521 sequentially passing through the upper and lower bearings 131, 132 in the bearing cup 111. The free end 1521 is latched with a retainer ring 16 for preventing the rotary shaft 152 from detaching out of the bearing cup 111. The fan impeller 15 is rotatably disposed on the base seat 11. When the stator assembly 12 is magnetized, the stator assembly 12 acts on the rotor assembly 151 to rotate the fan impeller 15 for creating airflow.

In assembling process of the conventional fan, when the retainer ring 16 is latched with the free end 1521 of the rotary shaft 152, it is necessary to press the lower bearing 132. This often leads to damage of the lower bearing 132. The damage of the lower bearing 132 will cause improper installation of the lower bearing 132, unbalanced load and stress concentration. As a result, the rotational precision is deteriorated and the lifetime of the fan is shortened. It is therefore tried by the applicant to provide a magnetic fan bearing structure to solve the problems of the conventional fan due to the damage of the lower bearing 132.

### SUMMARY OF THE INVENTION

It is therefore a primary object of the present invention to provide a bearing structure employing at least one magnetic member to solve the problems of improper installation of bearing, unbalanced load and stress concentration due to the damage of the lower bearing of the conventional fan.

It is a further object of the present invention to provide the above bearing structure, which includes a bearing cup. A bearing member and a first magnetic member are received in the bearing cup. The first magnetic member is disposed under the bearing member and has a first magnetic face radially facing a rotary shaft. By means of the bearing member and the first magnetic member, a fan impeller can keep stably operating at high rotational precision.

It is still a further object of the present invention to provide the above bearing structure, which includes a bearing cup. A bearing member, a first magnetic member and a second magnetic member are received in the bearing cup. The first and second magnetic members magnetically repel each other. The first magnetic member is disposed under the bearing member and vertically spaced from the bearing cup. The second magnetic member is disposed under the first magnetic member and vertically spaced from the first magnetic member. By means of the bearing member and the first and second magnetic members, the fan impeller can keep stably operating at high rotational precision.

It is still a further object of the present invention to provide the above bearing structure, which employs at least one magnetic member to provide magnetic cushioning effect for buffering the radial or radial and axial vibration of the rotary shaft so that the fan impeller can stably operate at high rotational precision.

It is a further object of the present invention to provide a fan having a bearing structure. The bearing structure includes a bearing cup. A bearing member and a first magnetic member are received in the bearing cup. The first magnetic member is disposed under the bearing member and has a first magnetic face radially facing a rotary shaft. By means of the bearing member and the first magnetic member, a fan impeller can keep stably operating.

It is still a further object of the present invention to provide the above fan. The fan has a bearing structure. The bearing structure includes a bearing cup. A bearing member, a first magnetic member and a second magnetic member are received in the bearing cup. The first and second magnetic members magnetically repel each other. The first magnetic member is disposed under the bearing member and vertically spaced from the bearing cup. The second magnetic member is disposed under the first magnetic member and vertically spaced from the first magnetic member. By means of the bearing member and the first and second magnetic members, the fan impeller can keep stably operating at high rotational precision.

To achieve the above and other objects, in the bearing structure of the present invention is inserted a rotary shaft. The rotary shaft has a free end. The bearing structure includes: a bearing cup having a first receiving space and a second receiving space and an inner flange section positioned between the first and second receiving spaces, the first and second receiving spaces being vertically formed in the bearing cup, the inner flange section horizontally protruding from an inner wall of the bearing cup toward a center thereof; a bearing member disposed in the first receiving space of the bearing cup, the bearing member having a shaft hole, the free end of the rotary shaft passing through the shaft hole; and a first magnetic member annularly disposed in the second receiving space of the bearing cup, the first magnetic member having a first perforation, the free end of the rotary shaft passing through the first perforation, inner circumference of the first perforation being defined as a first magnetic face radially facing the rotary shaft, the first magnetic member having a bottom side, the bottom side being defined as a second magnetic face.

The fan of the present invention includes: a base seat; a fan impeller having a hub and multiple blades formed on outer circumference of the hub, a rotor assembly being annularly disposed on inner circumference of the hub, a rotary shaft having a fixed end and a free end, the fixed end being connected with a top section of the hub; a bearing structure including a bearing cup, a bearing member and a first magnetic member, the bearing cup being formed on the base seat, the bearing cup having a first receiving space and a second receiving space and an inner flange section positioned between the first and second receiving spaces, the first and second receiving spaces being vertically formed in the bearing cup, the inner flange section horizontally protruding from an inner wall of the bearing cup toward a center thereof, the bearing member being disposed in the first receiving space of the bearing cup, the bearing member having a shaft hole, the free end of the rotary shaft passing through the shaft hole, the first magnetic member being annularly disposed in the second receiving space of the bearing cup, the first magnetic member having a first perforation, the free end of the rotary shaft passing through the first perforation, inner circumference of the first perforation being defined as a first magnetic face radially facing the rotary shaft, the first magnetic member having a bottom side, the bottom side being defined as a second magnetic face; and a stator assembly disposed on the base seat and fitted around the bearing cup corresponding to the rotor assembly for driving the fan impeller to rotate.

In the above bearing structure, the inner flange section has a free end proximal to the center of the bearing cup, the free end defining a coaxial hole between the first and second receiving spaces, the coaxial hole communicating with the first and second receiving spaces.

In the above bearing structure, the free end of the rotary shaft is latched with a retainer ring or a second magnetic member, the second magnetic member having a third magnetic face vertically spaced from the second magnetic face of the first magnetic member corresponding to the second magnetic face, the first magnetic member and the second magnetic member having the same polarity so that the second magnetic face and the third magnetic face will magnetically repel each other.

In the above bearing structure, the first magnetic member is an annular magnet.

In the above bearing structure, the second magnetic member is an annular plate-shaped magnet or a C-shaped magnet.

In the above bearing structure, the bearing has a first axial height and the first magnetic member has a second axial height, the second axial height being equal to or larger than the first axial height.

In the above bearing structure, a gap exists between the first magnetic face of the first magnetic member and the rotary shaft, whereby the first magnetic face is radially spaced from the rotary shaft to face the rotary shaft.

In the above bearing structure, the inner flange section has a top face and a bottom face on two sides, the bearing member abutting against the top face of the inner flange section, while the first magnetic member abutting against the bottom face of the inner flange section.

In the above bearing structure, the second magnetic face is vertically spaced from the third magnetic face by a distance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional assembled view of a conventional fan;

FIG. 2A is a perspective exploded view of a first embodiment of the present invention;

FIG. 2B is a sectional exploded view of the first embodiment of the present invention;

FIG. 2C is a sectional assembled view of the first embodiment of the present invention;

FIG. 2D is a sectional view of the bearing cup of the first embodiment of the present invention;

FIG. 2E is a sectional view of the bearing of the first embodiment of the present invention;

FIG. 2F is a sectional view of the first magnetic member of the first embodiment of the present invention;

FIG. 2G is a view showing the second magnetic face of the first magnetic member of the first embodiment of the present invention;

FIG. 2H is an enlarged view of circled area of FIG. 2;

FIG. 3A is a perspective exploded view of a second embodiment of the present invention;

FIG. 3B is a sectional exploded view of the second embodiment of the present invention;

FIG. 3C is a sectional assembled view of the second embodiment of the present invention;

FIG. 3D is a view showing the third magnetic face of the second magnetic member of the second embodiment of the present invention;

FIG. 4A is an enlarged view showing that the first magnetic member and the second magnetic member of the present invention repel each other in a first state; and

FIG. 4B is an enlarged view showing that the first magnetic member and the second magnetic member of the present invention repel each other in a second state.

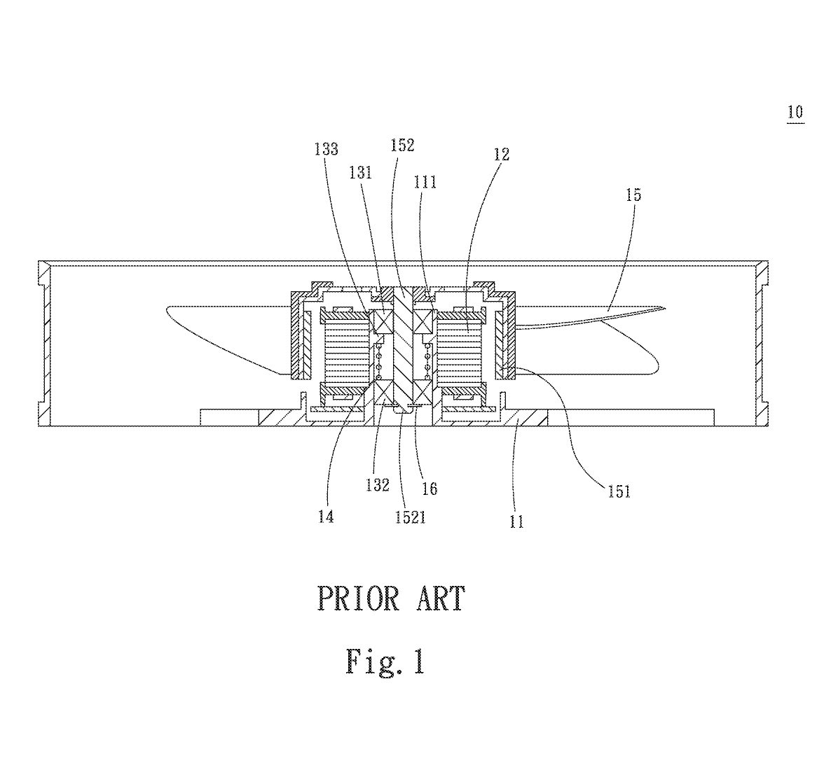

### DETAILED DESCRIPTION OF THE PREFERRED EMBODIMENTS

The embodiments of the present invention will be described hereinafter with reference to the drawings, wherein the same components are denoted with the same reference numerals.

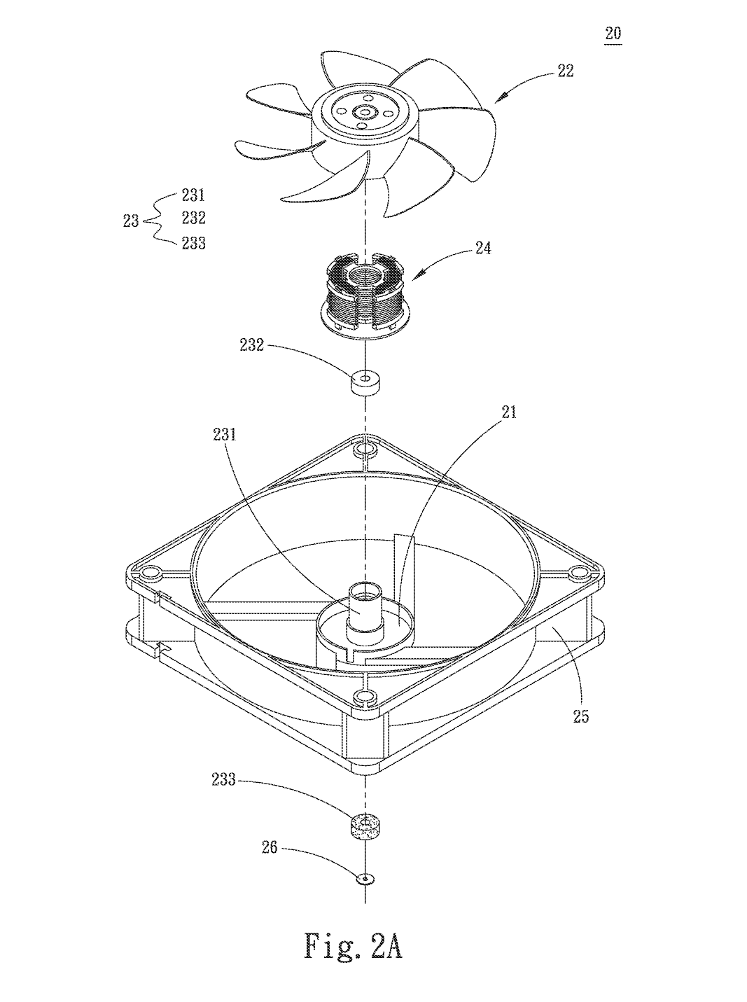

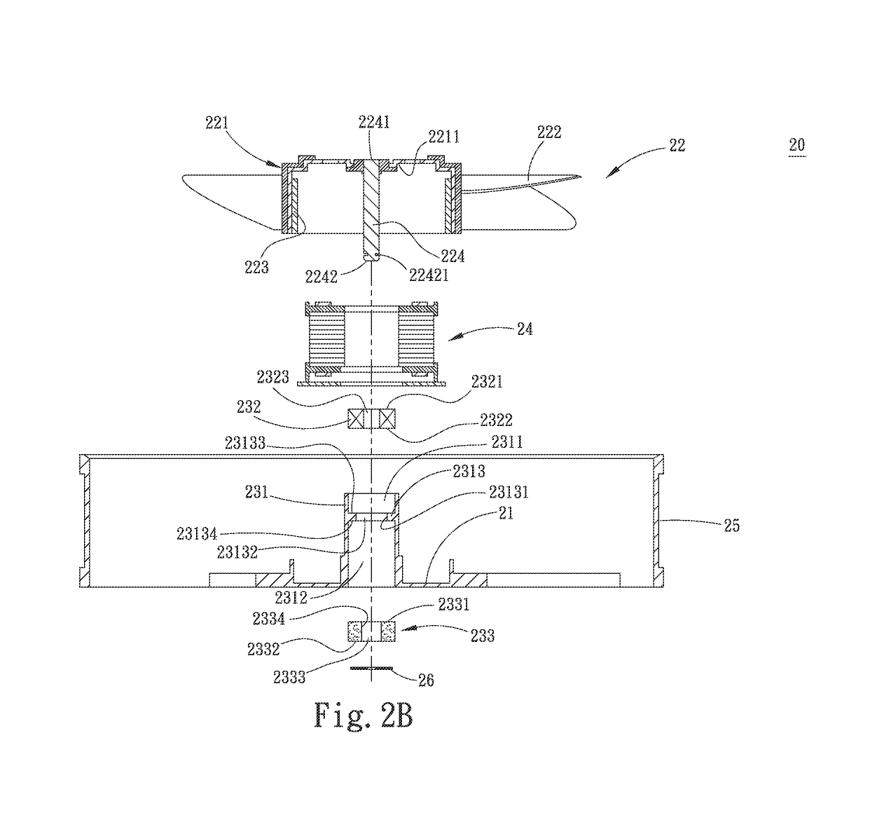

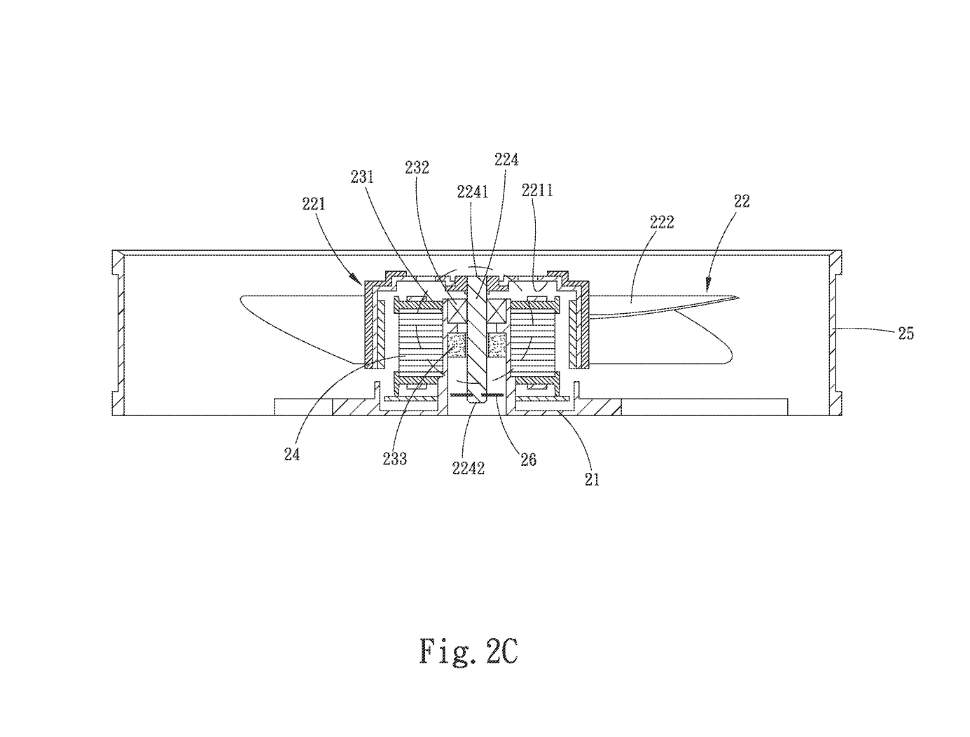

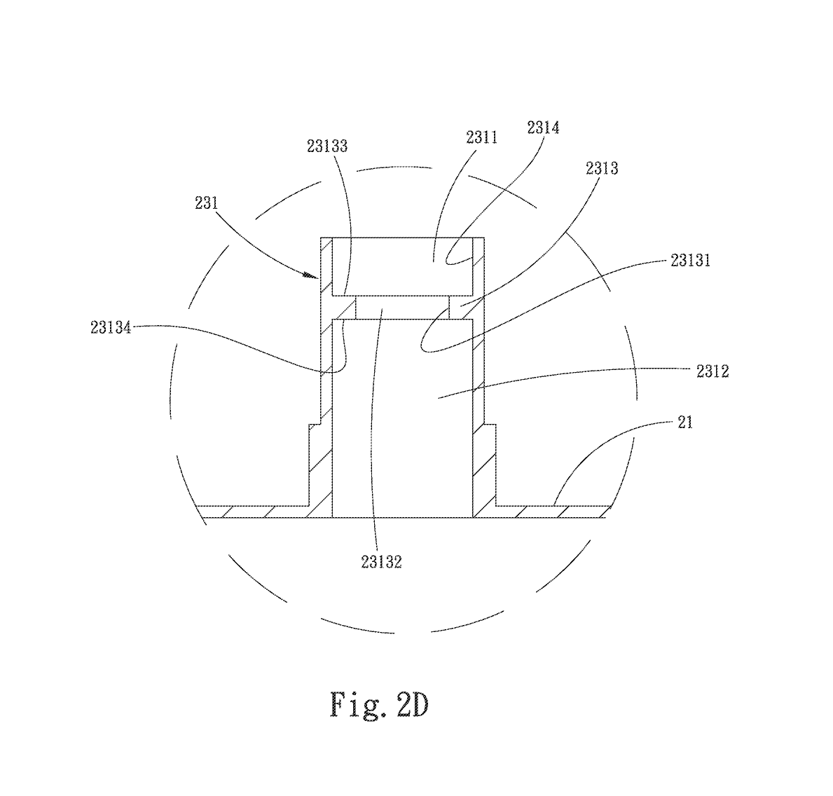

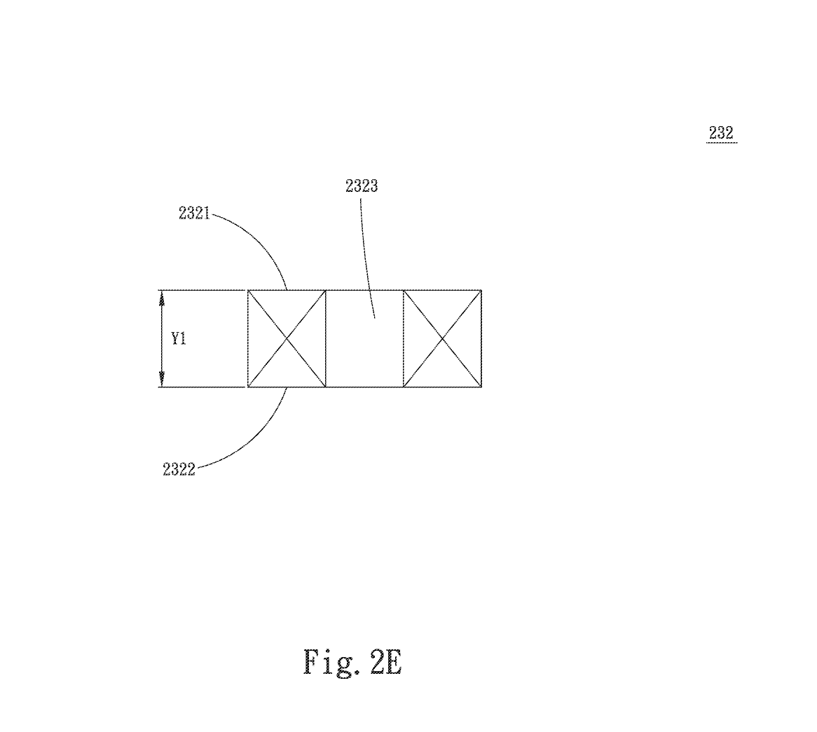

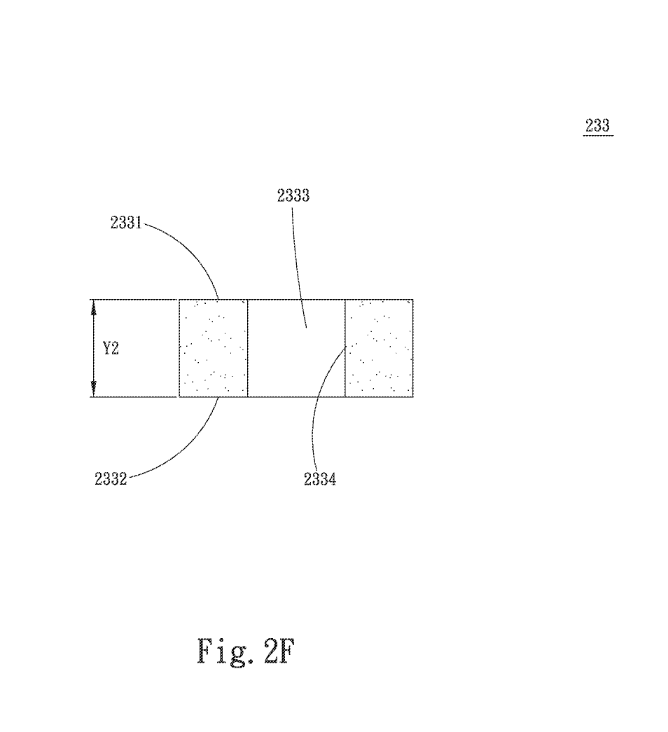

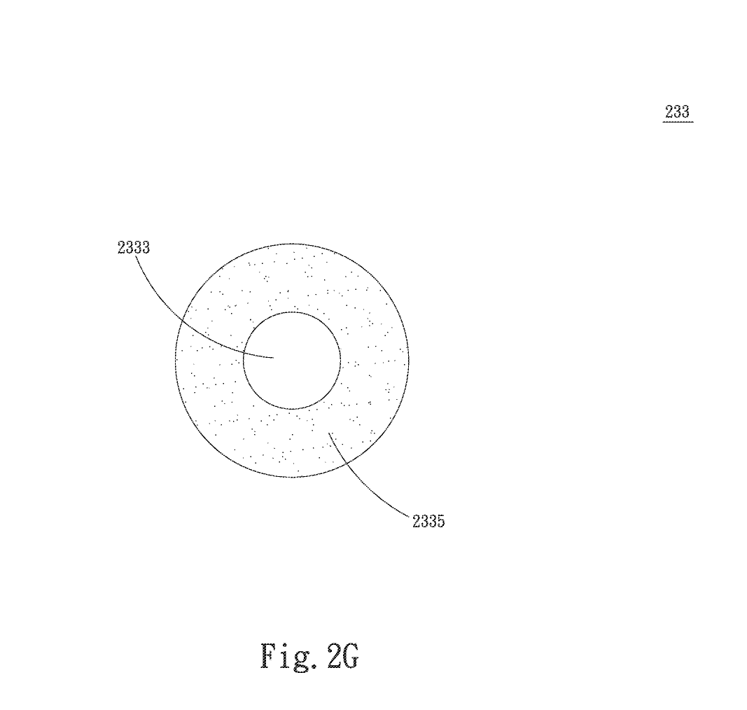

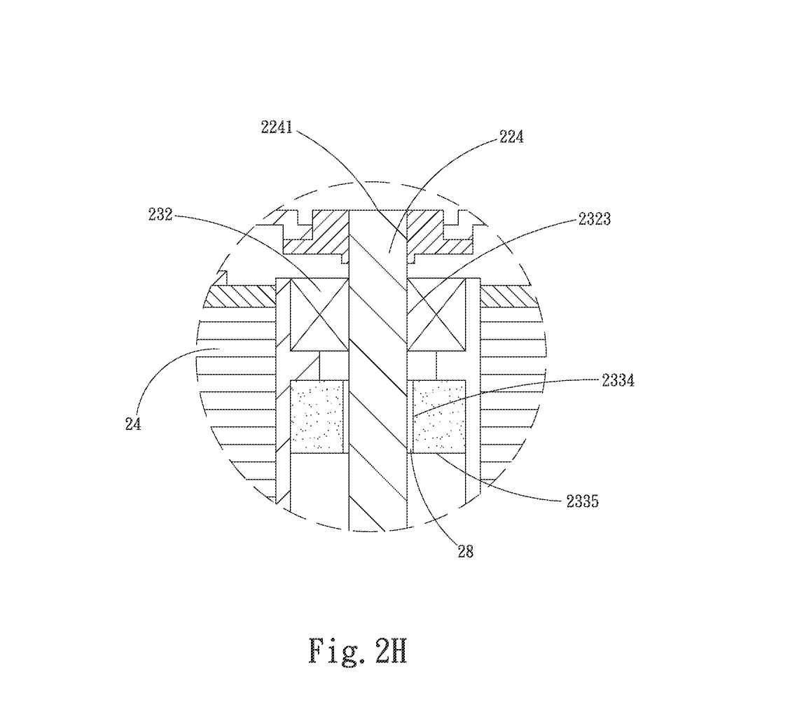

Please refer to FIGS. 2A to 2H. FIG. 2A is a perspective exploded view of a first embodiment of the present invention. FIG. 2B is a sectional exploded view of the first embodiment of the present invention. FIG. 2C is a sectional assembled view of the first embodiment of the present invention. FIG. 2D is a sectional view of the bearing cup of the first embodiment of the present invention. FIG. 2E is a sectional view of the bearing of the first embodiment of the present invention. FIG. 2F is a sectional view of the first magnetic member of the first embodiment of the present invention. FIG. 2G is a view showing the second magnetic face of the first magnetic member of the first embodiment of the present invention. FIG. 2H is an enlarged view of circled area of FIG. 2.

As shown in the drawings, the fan 20 of the present invention includes a base seat 21, a fan impeller 22, a bearing structure 23 and a stator assembly 24. The base seat 21 is disposed at the center of a fan frame 25. The fan impeller 22 has a hub 221 and multiple blades 222. The blades 222 are radially formed on outer circumference of the hub 221. The hub 221 has an inner circumference. A rotor assembly 223 such as, but not limited to an annular magnet is annularly disposed on the inner circumference of the hub 221. A rotary shaft 224 is disposed under a top section 2211 of the hub 221. The rotary shaft 224 has a fixed end 2241 and a free end 2242. The fixed end 2241 is connected with the top section 2211 of the hub 221. The free end 2242 is formed with a groove 22421. In this embodiment, the rotary shaft 224 is preferably made of magnetically attractable metal material such as pure iron, low-carbon steel, iron aluminum, iron silicon, iron nickel, iron-cobalt alloy, ferric oxide, nickel or cobalt.

The bearing structure 23 includes a bearing cup 231, a bearing member 232 and a first magnetic member 233. Referring to FIG. 2D, the bearing cup 231 is formed on the base seat 21 to upward protrude therefrom. The bearing cup 231 is a hollow structure having a first receiving space 2311 and a second receiving space 2312 and an inner flange section 2313 positioned between the first and second receiving spaces 2311, 2312. The first and second receiving spaces 2311, 2312 are vertically formed in the bearing cup 231. The inner flange section 2313 horizontally protrudes from an inner wall 2314 of the bearing cup 23 toward a center thereof. The inner flange section 2313 has a free end 23131 proximal to the center of the bearing cup 23. The free end 23131 defines a coaxial hole 23132 between the first and second receiving spaces 2311, 2312. The coaxial hole 23132 communicates with the first and second receiving spaces 2311, 2312. The inner flange section 2313 has a top face 23133 facing the first receiving space 2311 and a bottom face 23134 facing the second receiving space 2312 opposite to the top face 23133.

Referring to FIG. 2E, the bearing member 232 axially has an upper side 2321 and a lower side 2322 opposite to the upper side 2321. A shaft hole 2323 formed through the bearing member 232 from the upper side 2321 to the lower side 23222. A first axial height Y1 is defined between the upper and lower sides 2321, 2322. The bearing member 232 is disposed in the first receiving space 2311 of the bearing cup 231 with the lower side 2322 abutting against the top face 23133 of the inner flange section 2313. The free end 2242 of the rotary shaft 224 passes through the shaft hole 2323. Preferably, the rotary shaft 224 is fitted in the shaft hole 2323 by press fit (as shown in FIG. 2H). The rotary shaft 224 is supported by the bearing member 232 to vertically stand in the bearing cup 231. The bearing member 232 is such as, but not limited to, a ball bearing, a roller bearing, a needle roller bearing or an oil-retaining bearing.

Referring to FIG. 2F, the first magnetic member 233 has a top side 2331 and a bottom side 2332 opposite to the top side 2331. A first perforation 2333 is formed through the first magnetic member 233 from the top side 2331 to the bottom side 2332. A second axial height Y2 is defined between the upper and lower sides 2331, 2332. The first magnetic member 233 is annularly disposed in the second receiving space 2312 of the bearing cup 231 with the top side 2331 abutting against the bottom face 23134 of the inner flange section 2313. The free end 2242 of the rotary shaft 224 passes through the first perforation 2333. The inner circumference of the first perforation 2333 is defined as a first magnetic face 2334 around the rotary shaft 224. A gap 28 exists between the first magnetic face 2334 and the outer surface of the rotary shaft 224 (as shown in FIG. 2H). Accordingly, the first magnetic face 2334 is radially spaced from the outer surface of the rotary shaft 224 to face the outer surface of the rotary shaft 224. The lower side of the first magnetic member 233 is defined as a second magnetic face 2335 (as shown in FIG. 2G). The first magnetic member 233 is such as, but not limited to, an annular magnet. The outer circumference of the first magnetic member 233 is preferably fitted in the second receiving space 2312 of the bearing cup 231 by press fit.

It should be noted that the second axial height Y2 of the first magnetic member 233 is equal to or larger than the first axial height Y1 of the bearing member 232. Therefore, the second axial height Y2 of the first magnetic member 233 corresponds to a certain axial length of the rotary shaft 224. That is, the larger the second axial height Y2 of the first magnetic member 233 is, the longer the axial length of the rotary shaft 224 corresponding to the second axial height Y2 is. This means the area of the outer surface of the rotary shaft 224 under the magnetic effect is larger.

The stator assembly 24 is disposed on the base seat 21 and fitted around the bearing cup 231 corresponding to the rotor assembly 223. The stator assembly 24 includes a silicon steel sheet assembly composed of multiple stacked silicon steel sheets and a winding assembly wound around the silicon steel sheet assembly and a circuit board connected with the winding assembly. When powered on, the stator assembly 24 provides an electromagnetic effect.

When assembled, the free end 2242 of the rotary shaft 224 of the fan 20 is sequentially passed through the shaft hole 2323 of the bearing member 232 in the bearing cup 231 and the first perforation 2333 of the first magnetic member 233 to extend into the second receiving space 2312. Then, a retainer ring 26 such as, but not limited to, a plastic-made or metal-made C-shaped retainer ring is latched in the groove 22421 of the free end 2242 to prevent the rotary shaft 224 from detaching out of the bearing cup 231. The rotary shaft 224 is supported by the bearing member 232 and the first magnetic member 233 to stand in the bearing cup 231. The fan impeller 22 of the fixed end 2241 of the rotary shaft 24 is rotatably disposed on the base seat 21 with the rotor assembly 223 corresponding to the stator assembly 224. When powered on, the stator assembly 24 provides an electromagnetic effect for driving the fan impeller 22 to rotate.

The bearing member 232 is supported in a position adjacent to the fixed end 2241 of the rotary shaft 224 and the first magnetic member 233 is positioned in a position adjacent to a middle section of the rotary shaft 224 or a middle rear section of the rotary shaft 224. In this case, the first magnetic member 233 can provide a magnetic cushioning effect to buffer the radial vibration taking place when the rotary shaft 224 rotates. Therefore, the fan impeller 22 can stably operate. The first magnetic member 233 is used instead of the lower bearing of the conventional technique so that the problems of the conventional fan due to the damage of the lower bearing in the assembling process can be overcome.

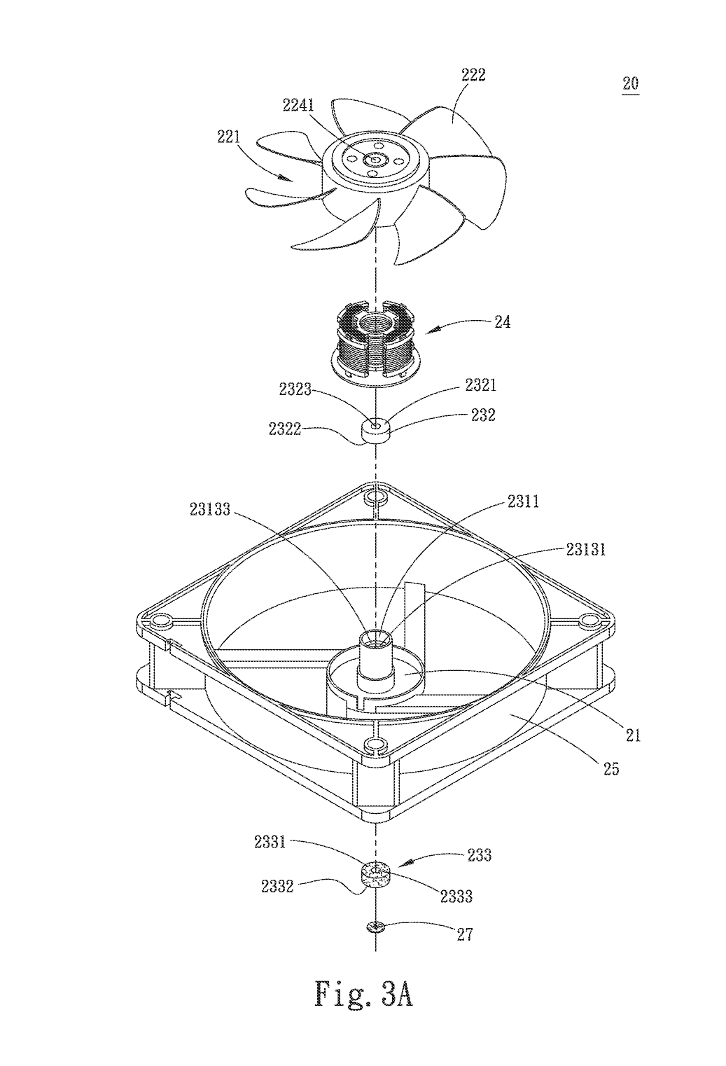

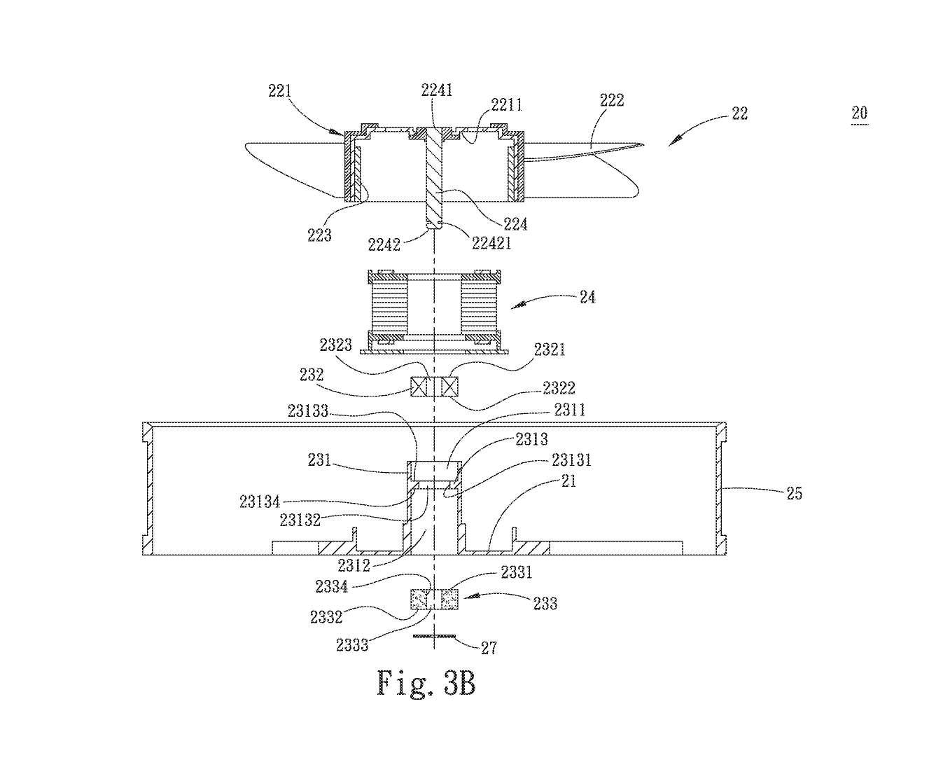

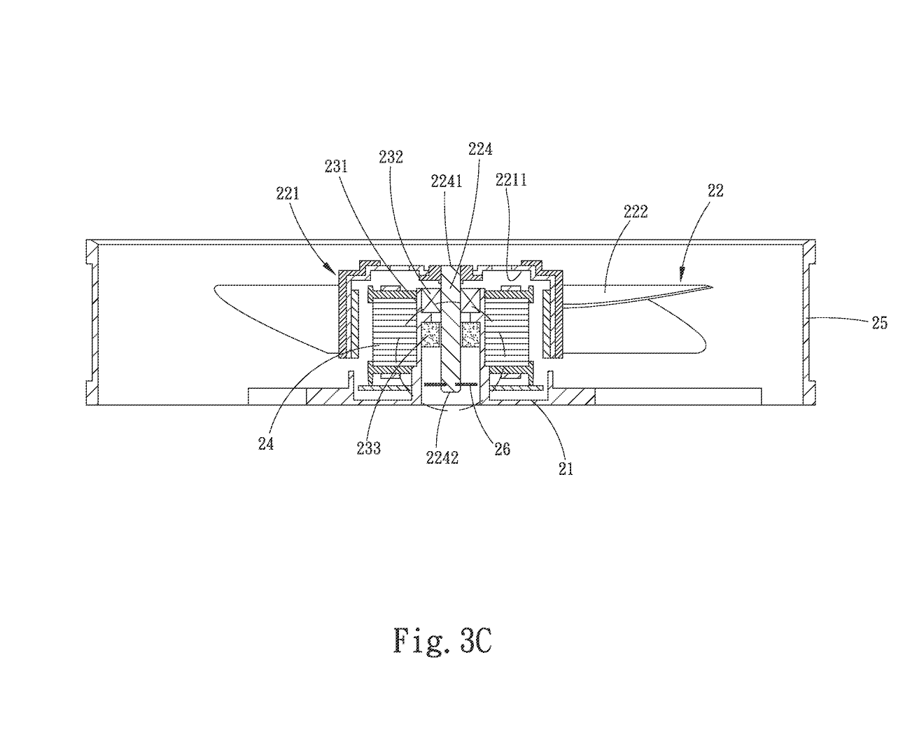

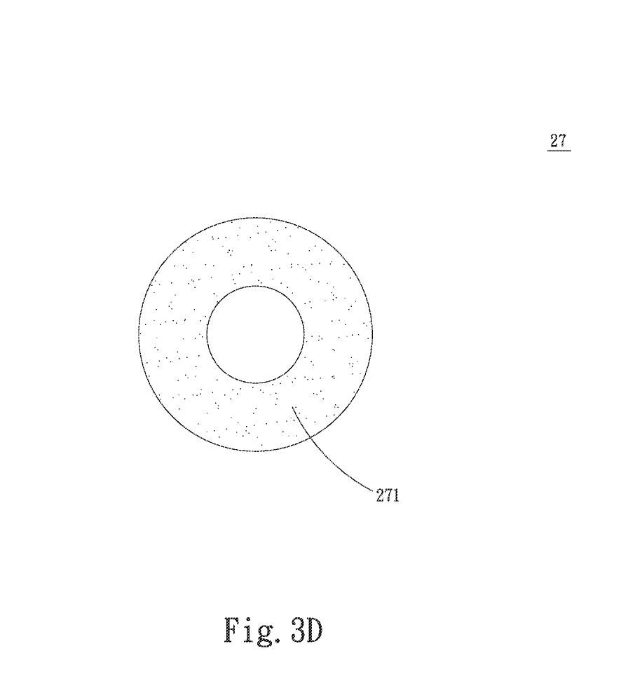

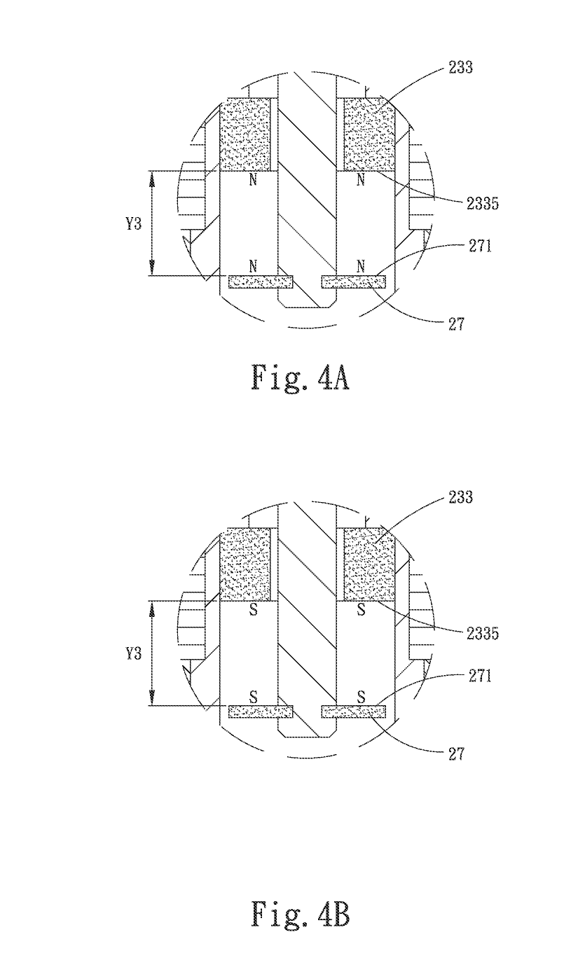

Please now refer to FIGS. 3A to 4B. FIG. 3A is a perspective exploded view of a second embodiment of the present invention. FIG. 3B is a sectional exploded view of the second embodiment of the present invention. FIG. 3C is a sectional assembled view of the second embodiment of the present invention. FIG. 3D is a view showing the third magnetic face of the second magnetic member of the second embodiment of the present invention. FIG. 4A is an enlarged view showing that the first magnetic member and the second magnetic member of the present invention repel each other in a first state. FIG. 4B is an enlarged view showing that the first magnetic member and the second magnetic member of the present invention repel each other in a second state. The second embodiment is substantially identical to the first embodiment in structure, connection relationship and effect and the same components are denoted with the same reference numerals. The second embodiment is different from the first embodiment in that the free end 2242 of the rotary shaft 224 is sequentially passed through the shaft hole 2323 of the bearing member 232 in the bearing cup 231 and the first perforation 2333 of the first magnetic member 233 to extend into the second receiving space 2312. Then, a second magnetic member 27 is latched in the groove 22421 of the free end 2242. The second magnetic member 27 is such as, but not limited to, an annular plate-shaped magnet or a C-shaped magnet. The second magnetic member 27 has a third magnetic face 271 facing the second magnetic face 2335 of the first magnetic member 233. The second magnetic face 2335 is spaced from the third magnetic face 271 by a vertical distance Y3 so that the second magnetic face 2335 is vertically spaced from the third magnetic face 271 to face the third magnetic face 271.

Especially, the first magnetic member 233 and the second magnetic member 26 have the same polarity such as N poles (as shown in FIG. 4A) or S poles (as shown in FIG. 4B). Therefore, the second magnetic face 2335 of the first magnetic member 233 and the third magnetic face 271 of the second magnetic member 27 will axially magnetically repel each other. This can effectively buffer the axial vibration taking place when the rotary shaft 224 rotates. Therefore, the fan impeller 22 can stably operate and the problems of the conventional fan due to the damage of the lower bearing in the assembling process can be overcome.

In conclusion, the present invention employs at least one magnetic member to provide magnetic cushioning effect for buffering the radial or radial and axial vibration of the rotary shaft. The magnetic member is used instead of the lower bearing of the conventional technique so that the problems of improper installation of bearing, unbalanced load and stress concentration due to the damage of the lower bearing of the conventional fan can be solved. In this case, the fan impeller can stably operate at high rotational precision.

The present invention has been described with the above embodiments thereof and it is understood that many changes and modifications in the above embodiments can be carried out without departing from the scope and the spirit of the invention that is intended to be limited only by the appended claims.

What is claimed is:

1. A bearing structure in which a rotary shaft is inserted, the rotary shaft having a free end, the bearing structure comprising:
a bearing cup having a first receiving space and a second receiving space and an inner flange section positioned between the first and second receiving spaces, the first and second receiving spaces being vertically formed in the bearing cup, the inner flange section horizontally protruding from an inner wall of the bearing cup toward a center thereof;
a bearing member disposed in the first receiving space of the bearing cup, the bearing member having a shaft hole, the free end of the rotary shaft passing through the shaft hole; and
a first magnetic member annularly disposed in the second receiving space of the bearing cup, the first magnetic member having a first perforation, the free end of the rotary shaft passing through the first perforation, inner circumference of the first perforation being defined as a first magnetic face radially facing the rotary shaft, the first magnetic member having a bottom side, the bottom side being defined as a second magnetic face.

2. The bearing structure as claimed in claim 1, wherein the inner flange section has a free end proximal to the center of the bearing cup, the free end defining a coaxial hole between the first and second receiving spaces, the coaxial hole communicating with the first and second receiving spaces.

3. The bearing structure as claimed in claim 1, wherein the free end of the rotary shaft is latched with a retainer ring or a second magnetic member, the second magnetic member having a third magnetic face vertically spaced from the second magnetic face of the first magnetic member corresponding to the second magnetic face, the first magnetic member and the second magnetic member having the same polarity so that the second magnetic face and the third magnetic face will magnetically repel each other.

4. The bearing structure as claimed in claim 3, wherein the first magnetic member is an annular magnet.

5. The bearing structure as claimed in claim 4, wherein the second magnetic member is an annular plate-shaped magnet or a C-shaped magnet.

6. The bearing structure as claimed in claim 1, wherein the bearing has a first axial height and the first magnetic member has a second axial height, the second axial height being equal to or larger than the first axial height.

7. The bearing structure as claimed in claim 1, wherein a gap exists between the first magnetic face of the first magnetic member and the rotary shaft, whereby the first magnetic face is radially spaced from the rotary shaft to face the rotary shaft.

8. The bearing structure as claimed in claim 1, wherein the inner flange section has a top face and a bottom face on two sides, the bearing member abutting against the top face of the inner flange section, while the first magnetic member abutting against the bottom face of the inner flange section.

9. The bearing structure as claimed in claim 3, wherein the second magnetic face is vertically spaced from the third magnetic face by a distance.

10. A fan comprising:
a base seat;
a fan impeller having a hub and multiple blades formed on outer circumference of the hub, a rotor assembly being annularly disposed on inner circumference of the hub, a rotary shaft having a fixed end and a free end, the fixed end being connected with a top section of the hub;
a bearing structure including a bearing cup, a bearing member and a first magnetic member, the bearing cup being formed on the base seat, the bearing cup having a first receiving space and a second receiving space and an inner flange section positioned between the first and second receiving spaces, the first and second receiving spaces being vertically formed in the bearing cup, the inner flange section horizontally protruding from an inner wall of the bearing cup toward a center thereof, the bearing member being disposed in the first receiving space of the bearing cup, the bearing member having a shaft hole, the free end of the rotary shaft passing through the shaft hole, the first magnetic member being annularly disposed in the second receiving space of the bearing cup, the first magnetic member having a first perforation, the free end of the rotary shaft passing through the first perforation, inner circumference of the first perforation being defined as a first magnetic face radially facing the rotary shaft, the first magnetic member having a bottom side, the bottom side being defined as a second magnetic face; and
a stator assembly disposed on the base seat and fitted around the bearing cup corresponding to the rotor assembly for driving the fan impeller to rotate.

11. The fan as claimed in claim 10, wherein the inner flange section has a free end proximal to the center of the bearing cup, the free end defining a coaxial hole between the first and second receiving spaces, the coaxial hole communicating with the first and second receiving spaces.

12. The fan as claimed in claim 10, wherein the free end of the rotary shaft is latched with a retainer ring or a second magnetic member, the second magnetic member having a third magnetic face vertically spaced from the second magnetic face of the first magnetic member corresponding to the second magnetic face, the first magnetic member and the second magnetic member having the same polarity so that the second magnetic face and the third magnetic face will magnetically repel each other.

13. The fan as claimed in claim 12, wherein the first magnetic member is an annular magnet.

14. The fan as claimed in claim 13, wherein the second magnetic member is an annular plate-shaped magnet or a C-shaped magnet.

15. The fan as claimed in claim 10, wherein the bearing has a first axial height and the first magnetic member has a second axial height, the second axial height being equal to or larger than the first axial height.

16. The fan as claimed in claim 10, wherein a gap exists between the first magnetic face of the first magnetic member and the rotary shaft, whereby the first magnetic face is radially spaced from the rotary shaft to face the rotary shaft.

17. The fan as claimed in claim 10, wherein the inner flange section has a top face and a bottom face on two sides, the bearing member abutting against the top face of the inner flange section, while the first magnetic member abutting against the bottom face of the inner flange section.

18. The fan as claimed in claim 12, wherein the second magnetic face is vertically spaced from the third magnetic face by a distance.
